(19) United States
(12) Patent Application Publication
(10) Pub. No.: US 2023/0214503 A1
(43) Pub. Date: Jul. 6, 2023

(54) ELECTRONIC DEVICE AND METHOD FOR PROCESSING USER INTERACTION INFORMATION

(71) Applicant: SAMSUNG ELECTRONICS CO., LTD., Suwon-si (KR)

(72) Inventors: Sunchul JUNG, Suwon-si (KR); Euntaik LEE, Suwon-si (KR); Eunsuk CHOI, Suwon-si (KR); Kyungtak HUR, Suwon-si (KR)

(73) Assignee: SAMSUNG ELECTRONICS CO., LTD., Suwon-si (KR)

(21) Appl. No.: 18/120,219

(22) Filed: Mar. 10, 2023

Related U.S. Application Data
(63) Continuation of application No. PCT/KR21/12299, filed on Sep. 9, 2021.

(30) Foreign Application Priority Data
Sep. 11, 2022 (KR) 10-2020-0116992

(51) Int. Cl. G06F 21/60; H04L 9/00; G06F 9/54

(52) U.S. Cl. CPC G06F 21/602; H04L 9/008; G06F 9/542

(57) ABSTRACT

A method for processing user interaction information by an electronic device, includes: executing an application in an unsecure area of the electronic device; instantiating an object of the application; recognizing a user interface of the application, converting a user reaction between a pseudo-event and the instantiated object into data, and transmitting the data to a secure area of the electronic device; mirroring the application to the secure area by using the data; based on a user input being detected, inferring an event to be recognized by a graphical user interface (GUI) framework of the electronic device; and interpreting, in the secure area, the user reaction to the instantiated object corresponding to the inferred event

### CROSS-REFERENCE TO RELATED APPLICATIONS

This application is a continuation application of International Application No. PCT/KR2021/012299, filed on Sep. 9, 2021, which claims priority to Korean Patent Application 10-2020-0116992, filed on Sep. 11, 2020, in the Korean Intellectual Property Office, the disclosures of which are incorporated by reference herein in their entireties.

### BACKGROUND

### 1. Field

The disclosure relates to a method for processing user interaction information and an electronic device including the method.

### 2. Description of Related Art

Modern operating systems may support rich graphical representations through an integrated graphical user interface (GUI) framework. In addition, the operating systems may provide programming interfaces and/or software development kits (SDKs) such that a related application may utilize the graphical representations in a consistent manner.

Applications based on a GUI may collect and/or process information on a user interaction with respect to a graphical object implemented on the applications.

A user may install various related applications in an electronic device and use the applications. However, security may be vulnerable in processing user interaction information collected by the applications.

### SUMMARY

Provided are a method for processing user interaction information and an electronic device including the method, in which user interaction information on an object of an application is processed as privacy information.

In addition, provided are a method for processing user interaction information and an electronic device which may process user interaction information on an object of an application as privacy information, so as to enhance security of user interaction information of a user interaction.

In addition, provided are a method for processing user interaction information and an electronic device which may automatically convert definite interaction information collectable by an application into a random variable, so as to enhance security of user interaction information of a user interaction.

Additional aspects will be set forth in part in the description which follows and, in part, will be apparent from the description, or may be learned by practice of the presented embodiments.

According to an aspect of the disclosure, a method for processing user interaction information by an electronic device, includes: executing an application in an unsecure area of the electronic device; instantiating an object of the application; recognizing a user interface of the application, converting a user reaction between a pseudo-event and the instantiated object into data, and transmitting the data to a secure area of the electronic device; mirroring the application to the secure area by using the data; based on a user input being detected, inferring an event to be recognized by a graphical user interface (GUI) framework of the electronic device; and interpreting, in the secure area, the user reaction to the instantiated object corresponding to the inferred event.

The method may further include generating input data based on the interpreted user reaction; and encrypting the input data in the secure area.

The encrypting the input data may include encrypting the input data by using a homomorphic encryption system.

The transmitting the data to the secure area may include recognizing the user interface and extracting the data from a physical interface corresponding to a valid event.

The transmitting the data to the secure area may further include generating key-data pair data of the physical interface corresponding to the user reaction corresponding to the instantiated object.

The mirroring the application may include at least one of: generating the pseudo-event while traversing a reaction list of the instantiated object; generating virtual user reactions to graphical reactive objects to generate a simulated response to the graphical reactive objects; and mirroring a rendered image generated to correspond to the pseudo-event to a secure buffer of the secure area.

The inferring of the event to be recognized by the GUI framework may include inferring the event to be recognized by the GUI framework by using a key-data pair in the secure area.

The application may be developed by using a software development kit (SDK) including an oblivious event receipt (OER) function.

According to an aspect of the disclosure, an electronic device includes: a display; a memory configured to store an application and an operating system; and a processor configured to execute the application and the operating system stored in the memory and operate while distinguishing between a secure area and a normal area, wherein the processor is further configured to: control to execute the application; instantiate an object of the application; recognize a user interface of the application, convert a user reaction between a pseudo-event and the instantiated object into data, and transmit the data to the secure area; mirror the application to the secure area by using the data; based on a user input being detected, infer an event to be recognized by a graphical user interface (GUI) framework; and interpret, in the secure area, the user reaction to the instantiated object corresponding to the inferred event.

The processor may be further configured to generate input data based on the interpreted user reaction; and encrypt the input data in the secure area.

The processor may be further configured to encrypt the input data by using a homomorphic encryption system.

The processor may be further configured to recognize the user interface and extract the data from a physical interface corresponding to a valid event.

The processor may be further configured to generate key-data pair data of the physical interface corresponding to the user reaction corresponding to the instantiated object.

The processor may be further configured to: generate the pseudo-event while traversing a reaction list of the instantiated object; generate virtual user reactions to graphical reactive objects to generate a simulated response to the graphical reactive objects; and mirror a rendered image generated to correspond to the pseudo-event to a secure buffer of the secure area.

The application may be developed by using a software development kit (SDK) including an oblivious event receipt (OER) function, and the processor may be further configured to infer the event to be recognized by the GUI framework by using a key-data pair in the secure area.

According to an aspect of the disclosure, a non-transitory computer-readable storage medium storing computer-executable instructions for processing user interaction information that, when executed by at least one processor of an electronic device, cause the electronic device to: execute an application in an unsecure area of the electronic device; instantiate an object of the application; recognize a user interface of the application, convert a user reaction between a pseudo-event and the instantiated object into data, and transmit the data to a secure area of the electronic device; mirror the application to the secure area by using the data; based on a user input being detected, infer an event to be recognized by a graphical user interface (GUI) framework of the electronic device; and interpret, in the secure area, the user reaction to the instantiated object corresponding to the inferred event.

The computer-executable instructions, when executed by the at least one processor, may further cause the electronic device to: generate input data based on the interpreted user reaction; and encrypt the input data in the secure area.

Encrypting the input data may include encrypting the input data by using a homomorphic encryption system.

Transmitting the data to the secure area may include recognizing the user interface and extracting the data from a physical interface corresponding to a valid event.

Transmitting the data to the secure area further may include generating key-data pair data of the physical interface corresponding to the user reaction corresponding to the instantiated object.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of an electronic device in a network environment, according to various embodiments of the present disclosure;

FIG. 2 illustrates user interaction information of an application based on a graphical user interface (GUI), according to various embodiments of the present disclosure;

FIG. 3 illustrates a user reaction to a reactive object, according to various embodiments of the present disclosure;

FIG. 4 is a block diagram illustrating an interaction among a user, an operating system, and an application of an electronic device, according to various embodiments of the present disclosure;

FIG. 5 is a flowchart illustrating an operation of processing user interaction information, according to various embodiments of the present disclosure; and

FIG. 6 is a flowchart illustrating an operation of processing user interaction information, according to various embodiments of the present disclosure.

### DETAILED DESCRIPTION

Hereinafter, various embodiments of this document may be described with reference to the accompanying drawings.

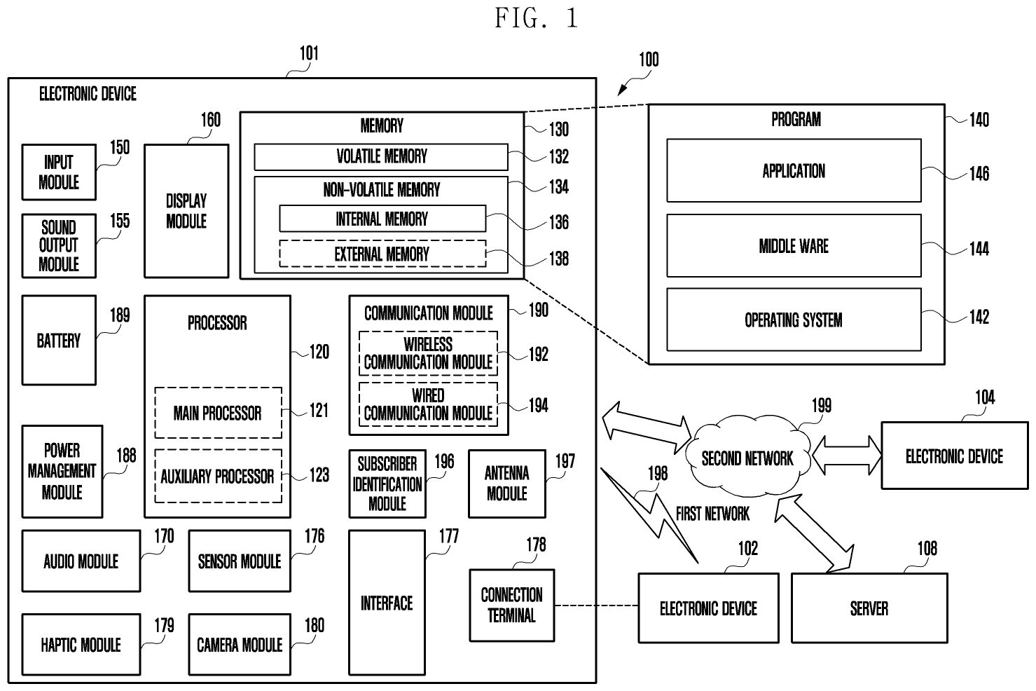

FIG. 1 is a block diagram illustrating an electronic device 101 in a network environment 100, according to various embodiments of the present disclosure. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an intemet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

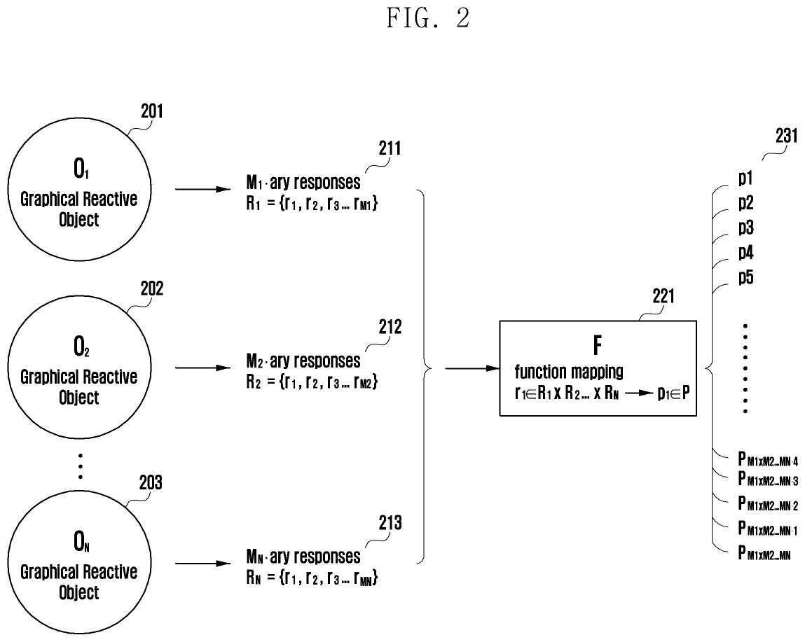

FIG. 2 illustrates user interaction information of an application based on a graphical user interface (GUI), according to various embodiments of the present disclosure.

A GUI-based application may include a plurality of graphical reactive objects (e.g., first graphical reactive object 201, second graphical reactive object 202, and third graphical reactive object 203).

The plurality of graphical reactive objects 201, 202, and 203 may collect user reactions (e.g., first user reaction 211, second user reaction 212, and third user reaction 213), respectively. For example, when the plurality of graphical reactive objects 201, 202, and 203 are user interface elements such as, but not limited to a button, the plurality of graphical reactive objects 201, 202, and 203 may collect a binary response (e.g., rᵢ∈R:={r1, r2}). Alternatively or additionally, when the plurality of graphical reactive objects 201, 202, and 203 are user interfaces such as, but not limited to, an analog phone dial, the plurality of graphical reactive objects 201, 202, and 203 may collect a 10-ary response (e.g, rᵢ∈R :={r1, r2, r3, r4, r5, r6, r7, r8, r9, r10}).

The user reactions 211, 212, and 213 collected by the application through the plurality of graphical reactive objects 201, 202, and 203 may be symbolized by rᵢ∈πRⱼ. For example, a symbolization operation may be defined in an application-specific method.

Continuing to refer to FIG. 2, the application may reprocess the collected user reactions 211, 212, and 213 into input data 231 by using a corresponding function 221.

In various embodiments, the input data 231 may be used as input data of a personal information service provided by the application.

The function 221 may structurize and/or process the user reactions 211, 212, and 213, which may be symbolized by rᵢ∈πRⱼ, into the input data 231 corresponding to a personal information service input.

In various embodiments, the cardinality of a user reaction Rⱼ may be greater than or equal to 2 (e.g., j∈{1, . . . , N}, where N≥2). For example, since an action in which the application collects a user reaction by using a graphical reactive object may be the same as the process of “multiple choice questions and answers”, the cardinality of the user reaction Rⱼ may be greater than or equal to 2 (e.g., j∈{1, . . . , N}, where N≥2).

In various embodiments, a user reaction collected using a graphical reactive object may be a collection targeted as personal information, and/or may be a security target.

In various embodiments, a graphical object requiring a unary response may not be a collection target of personal information on a user reaction. For example, a graphical object requiring the unary response may include, but not be limited to, an object relating to confirmation (e.g., OK) for moving to the next screen, an arrow object for inducing a screen slide (e.g., stepping to a next slide).

The application may symbolize an ambiguous user intention (e.g., the user reactions 211, 212, and 213) into rᵢ∈R, which may represent a standardized action through user experiences and/or user interfaces (e.g., the plurality of graphical reactive objects 201, 202, and 203) based on a GUI framework provided by an operating system. Alternatively or additionally, the application may process the user intentions (e.g., the user reactions 211, 212, and 213) into the input data 231 corresponding to an input of a personal information service model through the function 221.

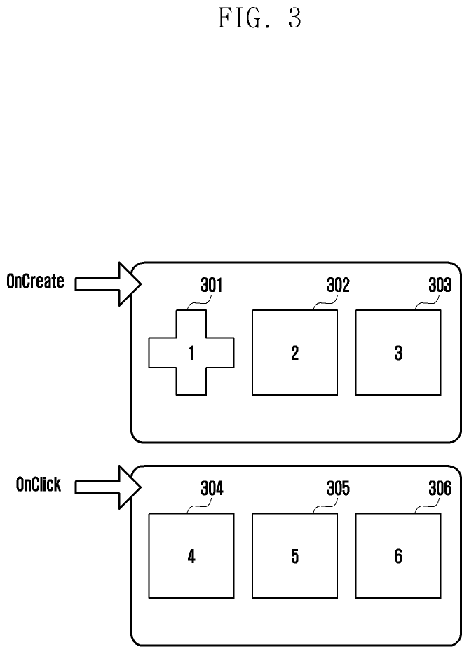

FIG. 3 illustrates a user reaction to a reactive object, according to various embodiments of the present disclosure.

As shown in FIG. 3, an application may include a plurality of graphical reactive objects (e.g., first graphical reactive object 301, second graphical reactive object 302, third graphical reactive object 303, fourth graphical reactive object 304, fifth graphical reactive object 305, and sixth graphical reactive object 306. The plurality of graphical reactive objects 301 to 306 of FIG. 3 may include or may be similar in many respects to the plurality of graphical reactive objects 201 to 203 of FIG. 2, and may include additional features not mentioned above.

An operating system of the electronic device 101 may generate a process for an application and may execute a given program. For example, the operating system of the electronic device 101 may notify an application process of a time point to instantiate the plurality of graphical reactive objects 301 to 306 as an event. Such an event may be referred to as an oncreate event. Alternatively or additionally, the operating system of the electronic device 101 may inform an application process that a user has reacted to at least one of the plurality of graphical reactive objects 301 to 306 as an event. Such an event may be referred to as an onclick event.

While FIG. 3 depicts the operating system of the electronic device 101 having the plurality of graphical reactive objects 301 to 306, the present disclosure is not limited in this regard. For example, the operating system of the electronic device 101 may include a smaller (less) amount of graphical reactive objects or a larger (more) amount of graphical reactive objects without deviating from the scope of the present disclosure. Alternatively or additionally, the operating system of the electronic device 101 may generate additional events that notify and/or inform an application process of the same and/or additional actions, reactions, and/or occurrences than those described above, without deviating from the scope of the present disclosure.

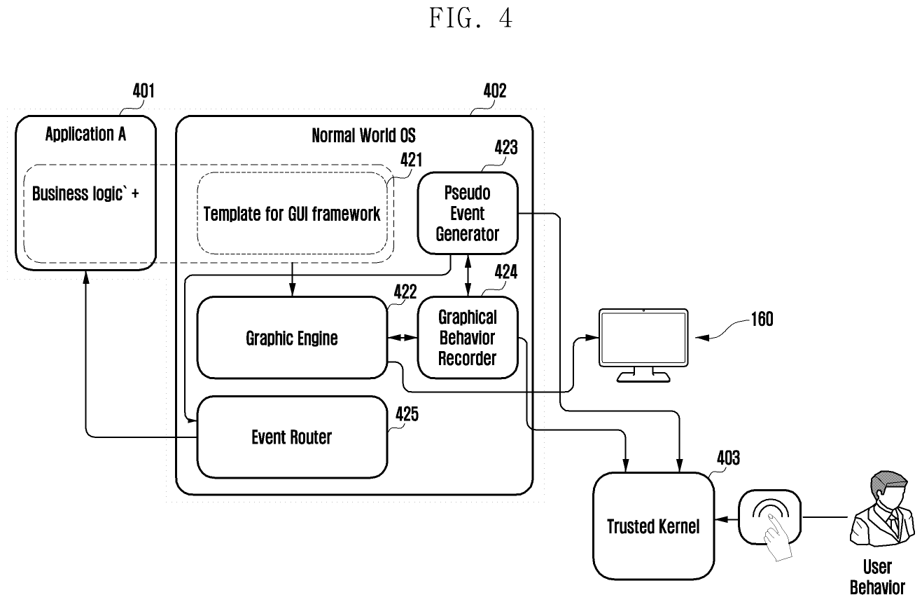

FIG. 4 is a block diagram illustrating an interaction among a user, an operating system, and an application of the electronic device 101, according to various embodiments of the present disclosure.

The electronic device 101 may include an application 401, an operating system 402, and/or a secure area 403.

The application 401, according to various embodiments, may be software developed using a software development kit (SDK) including an oblivious event receipt (OER) function. For example, the application 401 may include an oblivious event receipt (OER) function (not shown).

The OER function may allow a method to be automatically added to an object Oj (not shown) of the application 401. The OER function may allow recompiling the object Oj into a second object Oⱼ′ (not shown) that may be obtained through modulation of the object Oj of the application 401 by automatic addition of a method thereto.

In various embodiments, the OER function may induce the operating system 402 to call back to the added method instead of an original method. The OER function may vary according to an application development language, a paradigm, and an operating system design manner.

The OER function may standardize a user reaction symbolization-interpretation process (e.g., UXA-FA) that may be required to be processed when the object Oⱼ of the application 401 is called back by a user reaction by presenting an interface specification and/or an essential method to be overridden.

In various embodiments, the application 401 symbolizes an ambiguous user intention into rᵢ∈R, which may be a standardized action through a user experience framework (UXA) based on a GUI framework provided by the operating system 402. Alternatively or additionally, the application 401 may reprocess the user intentions into input data pᵢ∈P, which may be a data form suitable as an input of a service model S_{A}, through a function F_{A} (e.g., the function 221 of FIG. 2). For example, the application 401 may acquire a user value V_{A} through calculation of the service model S_{A} and input data P input thereto.

In various embodiments, the OER function may randomize a signature and the number of additional methods. Alternatively or additionally, the OER function may dynamically and/or statically provide the signature and the number of the additional methods according to a development language of the application.

The OER function may communicate with a trusted kernel of the secure area 403 by using a signature. The trusted kernel of the secure area 403 may be needed to encrypt pᵢ∈P corresponding to a user reaction into ENC (e.g., pᵢ∈P) and transmit the ENC to a backend part of business logic (e.g., business logic of application 401).

The operating system 402, according to various embodiments, may be an operating system which operates in a normal area (e.g., normal or unsecured environment).

In various embodiments, the secure area 403 may be implemented in physical isolation (e.g., a trusted execution environment (TEE)) from the operating system 402. Alternatively or additionally, the secure area 403 may be implemented in a framework of the normal area (e.g., normal or unsecured environment), which may provide a safety equivalent to the physical isolation.

The operating system 402 may include a GUI framework 421, a graphic engine 422, a pseudo-event generator 423, a graphical behavior recorder 424, and/or an event router 425.

When the application 401 is executed, the application 401 may register the application in the operating system 402. The application 402 may define symbolization-interpretation processing and/or data processing policies of a user reaction to a plurality of graphical reactive objects by using the operating system 402. The electronic device 101 may perform preparation in the GUI framework 421 to use a graphical representation provided by the operating system 402 on the display module 160. The electronic device 101 may display a visual interaction in response to a user input, on the display module 160, by using the graphic engine 422.

The event router 425 may process a user input collected through an input module (e.g., input module 150 of the electronic device 101 of FIG. 1). The electronic device 101 may interpret a user reaction, process data, and process life cycles of components according to an instruction (e.g., a program) of an application 401 by applying an application development template 401 provided by the operating system 402.

In various embodiments, the operating system 402 may be configured, in terms of execution of a GUI-based application, to perform abstraction into a graphic engine black box which may repeatedly draw a picture (e.g., graphical user interface) according to an instruction of the application, and/or perform abstraction into an input processing black box which may translate a physical input signal into an event corresponding to a layout of the application.

The pseudo-event generator 423 may be a part (e.g., peer process) of the operating system 402 and may perform an operation of generating a predetermined pseudo-event intended by the application 401 on behalf of a user.

In various embodiments, the pseudo-event generator 423 may identify arrangement information of graphical reactive objects and a user interface layout of the application 401 with an authority equal to that of the GUI framework 421, which may be provided by the operating system 402.

Alternatively or additionally, the pseudo-event generator 423 may identify information on a type of user reaction to the graphical reactive objects and information on a user input signal from a physical interface corresponding to a user reaction from layout information of the application 401. The user input signal from the physical interface may be, for example, information on an input coordinate when the input module 150 of the electronic device 101 is a touch screen. The pseudo-event generator 423 may generate a key-data pair with respect to a user reaction rᵢ and to a physical interface signal pᵢ, which may refer to a combination of physical interface signals pᵢ corresponding to all user reactions and transmit the key-data pair to the secure area 403.

In some embodiments, the pseudo-event generator 423 may generate virtual user reactions to graphical reactive objects included in the application 401 and transmit the generated user reactions to the event router 425 to trigger a dummy (e.g., simulated) response to the graphical reactive objects.

The graphical behavior recorder 424 may be a part (e.g., peer process) of the operating system 402. When the graphic engine 422 of the operating system 402 renders graphic processing intended as a visual interaction by the application 401 with respect to a predetermined event, the graphical behavior recorder 424 may mirror a rendering result to a regular target frame buffer (not shown) and/or another memory area. For example, an information format of a graphic behavior may include, but not be limited to, a continuous frame of the rendering result of the graphic engine, and a script and/or a set of encoded codes indicated by the application 401. However, the present disclosure is not limited in this regard. For example, the information format may vary according to the ability of an interpreter to interpret graphical behavior information.

The graphical behavior recorder 424 may participate in an operation of the graphic engine 422 with authority equal to that of the GUI framework. The graphical behavior recorder 424 may participate in allocation and compositing of a frame buffer for respective graphical reactive objects.

In some embodiments, the graphical behavior recorder 424 may transmit an image rendered by the graphic engine 422 of the operating system 402 to a separate auxiliary frame buffer (not shown), instead of the regular target frame buffer, according to graphic processing intended by the application 401 with respect to each user reaction which may be collected by a graphical reactive object.

The graphical behavior recorder 424 may mirror the image rendered in the auxiliary frame buffer to a trusted kernel residing in the secure area 403 via an interface of the secure area 403.

The secure area 403, according to various embodiments, may include a trusted kernel. The trusted kernel may be a secure process that may be executed within the secure area 403 and may interact with the pseudo-event generator 423 and/or the graphical behavior recorder 424, which are components of the operating system 402, and encrypt an input event. Alternatively or additionally, the trusted kernel of the secure area 403 may include a device driver which operates a physical interface which mediates an actual user's action in a secure mode.

The secure area 403 may refer to an area of which the processor 120 guarantees physical isolation and/or a program execution environment in the area. Alternatively or additionally, the secure area 403 may be include a sandbox process and/or a framework in which an independent address space may be implemented to have a sufficient security barrier within the operating system 402. For example, visual interaction information to be mirrored to the secure area by the graphical behavior recorder 424 may be replaced with a set of encoded codes describing a rendering method, rather than a rendering frame buffer calculated by the graphic engine 422 of the operating system 402.

The processor 120 of FIG. 1 may support physical isolation (e.g., a TEE), and, as such, may implement the normal area 402 and the secure area 403 in independent operation modes, respectively, and ensure the integrity and confidentiality of a code and/or data stored in the secure area 403. For example, in order to ensure the integrity and confidentiality of the code and/or data stored in the secure area 403, the processor 120 may control information exchange and/or instructions between the normal area 402 and the secure area 403. Alternatively or additionally, the processor 120 may limit the amount of types of resources required for program execution. For example, a library which may be included in a program may provide only a minimum amount of functions that may been verified to be error free (e.g., without errors such as buffer overflows). Due to these characteristics, it may not be possible to respond to complex visual processing requirements at a graphic engine level of the general operating system under the TEE. Therefore, a graphic reaction received from the graphical behavior recorder 424 may be a simple image stream in which complexity of a rendering process may have been reduced or eliminated.

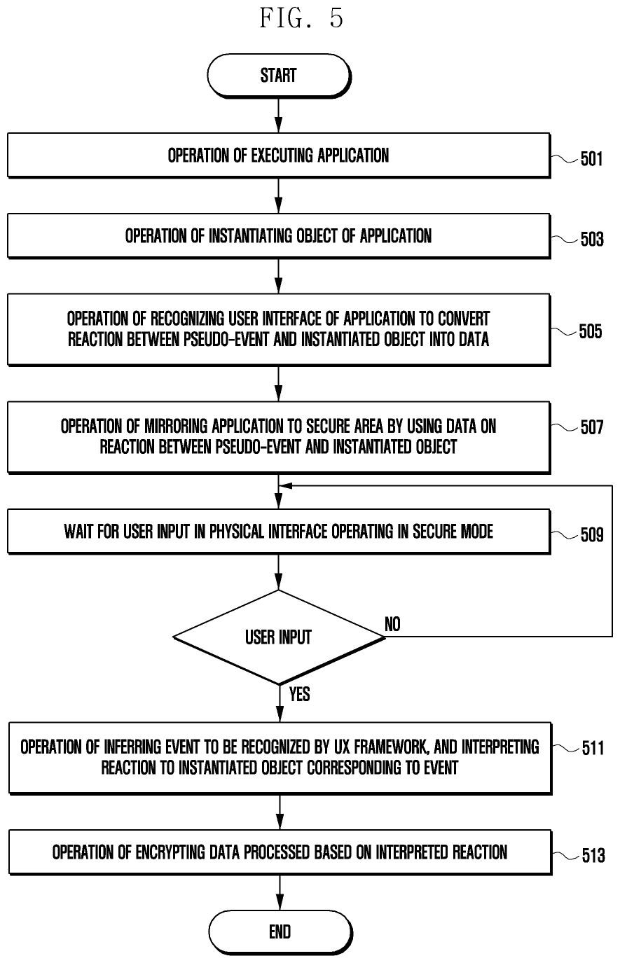

FIG. 5 is a flowchart illustrating an operation of processing user interaction information, according to various embodiments of the present disclosure.

In operation 501, under the control of the processor 120, the electronic device 101 may perform an operation of executing the application 401. The application 401 may be executed by a user input.

In operation 503, under the control of the processor 120, the electronic device 101 may perform an operation of instantiating an object of the application 401.

In various embodiments, in operation 503, under the control of the processor 120, the electronic device 101 may perform, for example, an operation of generating a real object from an abstracted object in order to define a specific transformation with respect to the object of the application 401.

In operation 505, under the control of the processor 120, the electronic device 101 may perform an operation of recognizing a user interface of the application 401 and converting a user reaction between a pseudo-event and the instantiated object into data.

In various embodiments, in operation 505, under the control of the processor 120, the electronic device 101 may extract data from a physical interface corresponding to the user reaction corresponding to the object of the application 401 and convert the same into data.

In various embodiments, in operation 505, under the control of the processor 120, the electronic device 101 may transmit data from a physical interface corresponding to the user reaction corresponding to the instantiated object as a key-data pair to a secure area (e.g., the secure area 403 of FIG. 4).

In various embodiments, in operation 505, under the control of the processor 120, the electronic device 101 may extract a coordinate on the display module 160 corresponding to an object and/or a layout of the user interface of the application 401.

Under the control of the processor 120, the electronic device 101 may transmit the data of the physical interface corresponding to the user reaction corresponding to the instantiated object as the key-data pair to the secure area (e.g., the secure area 403).

In operation 507, under the control of the processor 120, the electronic device 101 may mirror the application 401 to the secure area (e.g., the secure area 403) by using data on the user reaction between the pseudo-event and the instantiated object.

The operation of mirroring the application 401 may be, for example, an operation of copying a screen of the application 401 being executed.

In various embodiments, in operation 507, under the control of the processor 120, the electronic device 101 may generate a pseudo-event while traversing a reaction list for the instantiated object.

In various embodiments, in operation 507, under the control of the processor 120, the electronic device 101 may perform a pseudo-event generation operation so as to process only a graphical reactive object among instantiated objects.

In various embodiments, in operation 507, under the control of the processor 120, the electronic device 101 may generate virtual user reactions to graphical reactive objects included in the application 401, and trigger a dummy (e.g., simulated) response to the graphical reactive objects.

In various embodiments, in operation 507, under the control of the processor 120, the electronic device 101 may generate rendering by performing graphic processing intended by the application 401 with respect to a predetermined event, and mirror a rendering result (or a rendered image) to a target frame buffer and/or another memory area.

In various embodiments, in operation 507, under the control of the processor 120, the electronic device 101 may generate the pseudo-event by using the pseudo-event generator 423, and mirror data on a visual interaction of the user interface of the application 401 to the secure area 403 by using the graphical behavior recorder 424.

In various embodiments, in operation 507, under the control of the processor 120, the electronic device 101 may request a secure buffer queue obtained by indexing an event into the secure area 403.

In various embodiments, in operation 507, under the control of the processor 120, the electronic device 101 may mirror the rendered image to a secure buffer of the secure area 403.

In operation 509, under the control of the processor 120, the electronic device 101 may wait for a user reaction from a physical interface operating in a secure mode.

In operation 511, under the control of the processor 120, the electronic device 101 may determine whether a user input has been received.

When the user input is received (YES on user input), the electronic device 101 may branch to operation 511.

When the user input is not received (NO on user input), the electronic device 101 may branch to operation 509.

In operation 513, under the control of the processor 120, the electronic device 101 may infer an event according to the user input received through the physical interface, and interpret a reaction to an instantiated object corresponding to the event.

In operation 513, under the control of the processor 120, the electronic device 101 may infer an event to be recognized by a GUI framework by using the key-data pair in the secure area.

In operation 513, under the control of the processor 120, the electronic device 101 may refer to (access) a secure buffer for each event mirrored in the secure area, and replicate a corresponding event to a secure frame buffer. The secure frame buffer may be referred to (accessed) by a display compositing driver.

In operation 513, under the control of the processor 120, the electronic device 101 may interpret a user reaction with respect to the instantiated object in the secure area 403. For example, the electronic device may generate input data on the user reaction by using a function. The input data may be data input to a service model of the application 401.

In various embodiments, in operation 513, under the control of the processor 120, the electronic device 101 may infer an event on the object and/or the layout of the application 401 corresponding thereto from key-data (e.g., a coordinate on the display module 160). In operation 513, under the control of the processor 120, the electronic device 101 may provide, to the graphic engine 422, information (e.g., an address of a secure frame buffer) of the data (e.g., a contiguous secure frame buffer) on the visual interaction of the user interface of the application mirrored to the secure area 403 from the inferred event, so that a trusted kernel (e.g., of secure area 403) may copy the operation of the application 401.

In various embodiments, in operation 513, under the control of the processor 120, the electronic device 101 may call back an event handler with respect to an object having a hashed signature, and interpret a user reaction and input data pᵢ with respect to the object of the application 401. The trusted kernel may call back the event handler under the control of the processor 120. The hashed signature may be hashed by a SDK. In various embodiments, the application 401 included in the electronic device 101 may execute reaction interpretation for an instantiated object corresponding to an event by using a modified code instead of an original code, while maintaining business logic. For example, a method describing the operation of the object of the application 401 may be added and/or modified.

In operation 513, under the control of the processor 120, the electronic device 101 may encrypt the input data processed based on the user reaction interpreted in the secure area 403.

In operation 513, under the control of the processor 120, the electronic device 101 may encrypt the input data processed based on the user reaction interpreted in the secure area 403 by using a homomorphic encryption system.

In operation 513, under the control of the processor 120, the electronic device 101 may encrypt the input data processed based on the reaction interpreted in the secure area 403 and transmit the encrypted input data to a server.

In operation 513, under the control of the processor 120, the electronic device 101 may transmit information obtained by encrypting the input data processed based on the user reaction interpreted in the secure area 403 to a backend part of the business logic of the application 401.

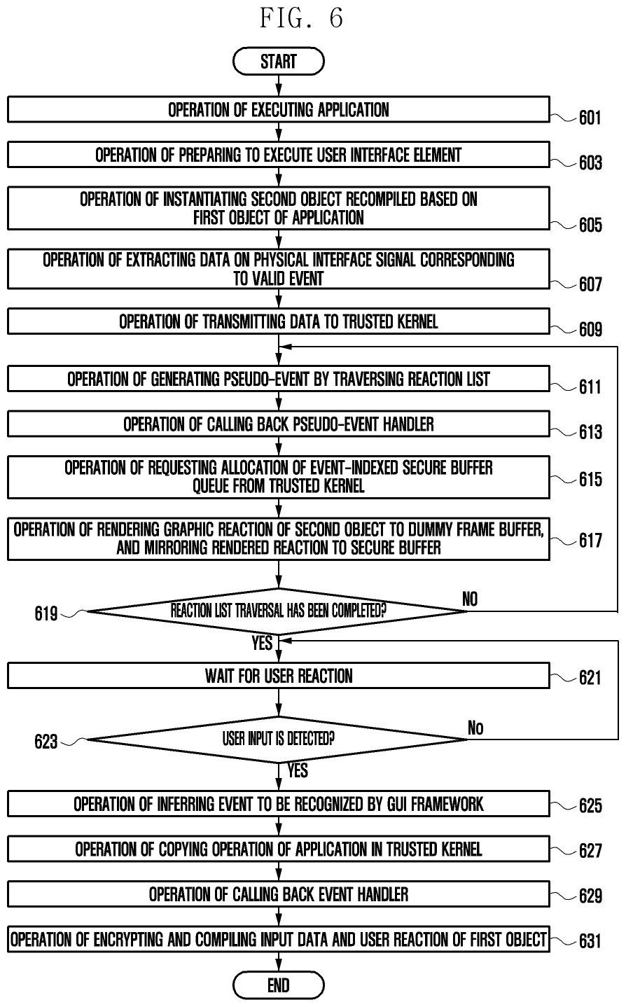

FIG. 6 is a flowchart illustrating an operation of processing user interaction information, according to various embodiments of the present disclosure.

In operation 601, under the control of the processor 120, the electronic device 101 may perform an operation of executing the application 401. The application 401 may be executed by a user input.

In operation 603, under the control of the processor 120, the electronic device 101 may prepare to execute a user interface element for an operation of the application 401 in the operating system 403.

In various embodiments, in operation 603, under the control of the processor 120, the electronic device 101 may prepare to execute the application 401 on a GUI framework.

The user interface element may be, for example, a GUI, and the user interface element may be an object and/or a component used in the application 401. The operation of preparing the execution of the user interface element for the operation of the application 401 in the operating system 403 may be, for example, an operation of calling and/or executing an object, a UI, and/or a GUI element of the application 401.

In various embodiments, in operation 605, the electronic device 101 may instantiate a second object recompiled based on a first object of the application 401. The first object of the application 401 may refer to objects created and/or selected by an application developer. The second object may refer to objects obtained by recompiling the first object by a SDK.

In various embodiments, in operation 605, under the control of the processor 120, the electronic device 101 may perform the operation of instantiating the second object recompiled based on the first object of the application 401 in order to define a specific transformation with respect to the object of the application 401, and may perform, for example, an operation of generating a real object from an abstracted object.

In various embodiments, in operation 607, the electronic device 101 may extract data from a physical interface signal corresponding to a valid event.

In operation 607, under the control of the processor 120, the electronic device 101 may perform an operation of recognizing a user interface of the application 401 and converting a user reaction between a pseudo-event and the instantiated object into data.

In various embodiments, in operation 607, under the control of the processor 120, the electronic device 101 may extract data from a physical interface corresponding to the user reaction corresponding to the object of the application 401 and convert the same into data.

In various embodiments, in operation 607, under the control of the processor 120, the electronic device 101 may extract a coordinate on the display module 160 corresponding to an object and/or a layout of the user interface of the application.

In various embodiments, in operation 609, under the control of the processor 120, the electronic device 101 may transmit data of a physical interface corresponding to the user reaction corresponding to the instantiated object to a trusted kernel.

In various embodiments, in operation 609, under the control of the processor 120, the electronic device 101 may transmit the data of the physical interface corresponding to the user reaction corresponding to the instantiated object as a key-data pair to a secure area (e.g., the secure area 403).

In various embodiments, in operation 611, under the control of the processor 120, the electronic device 101 may generate a pseudo-event while traversing a reaction list. In operation 611, under the control of the processor 120, the electronic device 101 may generate the pseudo-event by using the pseudo-event generator 423, and mirror data on a visual interaction of the user interface of the application 401 to the secure area 403 by using the graphical behavior recorder 424.

The reaction list may be a list of objects which can be interacted by an event (e.g., a touch event and/or a user input) among the data on the visual interaction of the user interface.

In various embodiments, in operation 613, under the control of the processor 120, the electronic device 101 may call back a pseudo-event handler. In various embodiments, in operation 613, under the control of the processor 120, the electronic device 101 may call back the pseudo-event handler in order to process a pseudo-event for the second object compiled to process only a graphic reaction part in the first object.

In operation 615, under the control of the processor 120, the electronic device 101 may request allocation of an event-indexed secure buffer queue from the trusted kernel.

In various embodiments, in operation 615, under the control of the processor 120, the electronic device 101 may request allocation of an event-indexed secure buffer queue from the trusted kernel by using the graphical behavior recorder 424.

In operation 615, under the control of the processor 120, the electronic device 101 may request the trusted kernel to allocate and/or wait for a secure buffer having an index with respect to an event.

In operation 617, under the control of the processor 120, the electronic device 101 may render a graphic reaction (and/or a user reaction) of the second object to a dummy frame buffer, and mirror the rendered reaction to the secure buffer.

In various embodiments, in operation 617, under the control of the processor 120, the electronic device 101 may render a graphic reaction (and/or a user reaction) of the second object to the dummy frame buffer, and mirror the rendered reaction to the secure buffer by using the graphical behavior recorder 424.

In various embodiments, in operation 617, under the control of the processor 120, the electronic device 101 may generate virtual user reactions to graphical reactive objects included in the application 401, and trigger a dummy (e.g., simulated) response to all the graphical reactive objects.

In various embodiments, in operation 617, under the control of the processor 120, the electronic device 101 may generate rendering by performing graphic processing intended by the application 401 with respect to a predetermined event, and mirror a rendering result (or a rendered image) to a target frame buffer and/or another memory area.

In various embodiments, in operation 617, under the control of the processor 120, the electronic device 101 may generate a pseudo-event by using the pseudo-event generator 423, and mirror data on a visual interaction of the user interface of the application 401 to the secure area 403 by using the graphical behavior recorder 424.

In various embodiments, in operation 619, under the control of the processor 120, the electronic device 101 may determine whether a reaction list traversal has been completed.

In various embodiments, under the control of the processor 120, the electronic device 101 may branch to operation 621 when it is determined that the reaction list traversal has been completed (YES at operation 619).

In various embodiments, under the control of the processor 120, the electronic device 101 may branch to operation 611 when the reaction list traversal has not been completed (NO at operation 619).

In various embodiments, in operation 621, under the control of the processor 120, the electronic device 101 may wait for a user reaction.

In various embodiments, in operation 623, under the control of the processor 120, the electronic device 101 may determine whether a user input has been detected.

In various embodiments, under the control of the processor 120, the electronic device 101 may branch to operation 625 when the user input is detected (YES at operation 623).

In various embodiments, under the control of the processor 120, the electronic device 101 may branch to operation 621 when there is no user input (NO at operation 623).

In operation 625, under the control of the processor 120, the electronic device 101 may infer an event to be recognized by the GUI framework.

In various embodiments, in operation 625, under the control of the processor 120, the electronic device 101 may infer an event to be recognized by the GUI framework, based on the key-data pair for a valid event (or user reaction)-physical interface signal provided by the pseudo-event generator 423 by using the trusted kernel (e.g., of the secure area 403).

In various embodiments, in operation 625, under the control of the processor 120, the electronic device 101 may infer an event according to the user input received through the physical interface by using the trusted kernel (e.g., of the secure area 403), and interpret a reaction to an instantiated object corresponding to the event.

In various embodiments, in operation 625, under the control of the processor 120, the electronic device 101 may refer to (access) a secure buffer for each event mirrored in the secure area 403, and replicate a corresponding event to a secure frame buffer. The secure frame buffer may be referred to (accessed) by an actual display compositing driver and/or the graphic engine 422.

In various embodiments, in operation 627, under the control of the processor 120, the electronic device 101 may provide, to the graphic engine 422, information (e.g., an address of a secure frame buffer) of the data (e.g., a contiguous secure frame buffer) on the visual interaction of the user interface of the application mirrored to the secure area 403 from the inferred event, so that the trusted kernel (e.g., of the secure area 403) may copy the operation of the application 401.

In operation 629, under the control of the processor 120, the electronic device 101 may call back an event handler.

In various embodiments, in operation 629, under the control of the processor 120, the electronic device 101 may call back an event handler with respect to an object having a hashed signature. The trusted kernel (e.g., of the secure area 403) may call back the event handler under the control of the processor 120. The hashed signature may be hashed by a SDK. In various embodiments, the application 401 included in the electronic device 101 may execute reaction interpretation for an instantiated object corresponding to an event by using a modified code instead of an original code, while maintaining business logic. For example, a method describing the operation of the object of the application 401 may be added and/or modified.

In operation 631, under the control of the processor 120, the electronic device 101 may transmit data obtained by interpreting, encrypting, and compiling a user reaction and input data pᵢ with respect to the first object of the application 401 to a backend of the application 401.

In various embodiments, in operation 631, under the control of the processor 120, the electronic device 101 may encrypt the input data processed based on the user reaction interpreted in the secure area 403.

In operation 631, under the control of the processor 120, the electronic device 101 may encrypt the input data processed based on the user reaction interpreted in the secure area by using a homomorphic encryption system.

In operation 631, under the control of the processor 120, the electronic device 101 may encrypt the input data processed based on the reaction interpreted in the secure area 403, and transmit the encrypted input data to a server.

In operation 631, under the control of the processor 120, the electronic device 101 may transmit information obtained by encrypting the input data processed based on the user reaction interpreted in the secure area 403 to a backend part of the business logic of the application 401.

The electronic device, according to various embodiments disclosed herein, may be one of various types of electronic devices. The electronic devices may include, for example, a portable communication device (e.g., a smart phone), a computer device, a portable multimedia device, a portable medical device, a camera, a wearable device, or a home appliance. The electronic device, according to embodiments of the present disclosure, is not limited to those described above.

It is to be appreciated that various embodiments of the present disclosure and the terms used therein are not intended to limit the technological features set forth herein to particular embodiments and include various changes, equivalents, or alternatives for a corresponding embodiment. With regard to the description of the drawings, similar reference numerals may be used to designate similar or relevant elements. A singular form of a noun corresponding to an item may include one or more of the items, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “a first”, “a second”, “the first”, and “the second” may be used to simply distinguish a corresponding element from another, and does not limit the elements in other aspect (e.g., importance or order). It is to be understood that if an element (e.g., a first element) is referred to, with or without the term “operatively” or “communicatively”, as “coupled with/to” or “connected with/to” another element (e.g., a second element), it means that the element may be coupled/connected with/to the other element directly (e.g., wiredly), wirelessly, or via a third element.

As used herein, the term “module” may include a unit implemented in hardware, software, or firmware, and may be interchangeably used with other terms, for example, “logic,” “logic block,” “component,” or “circuit”. The “module” may be a minimum unit of a single integrated component adapted to perform one or more functions, or a part thereof. For example, according to an embodiment, the “module” may be implemented in the form of an application-specific integrated circuit (ASIC).

Various embodiments as set forth herein may be implemented as software (e.g., the program 140) including one or more instructions that are stored in a storage medium (e.g., the internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. The term “non-transitory” may indicate that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each element (e.g., a module or a program) of the above-described elements may include a single entity or multiple entities, and some of the multiple entities mat be separately disposed in any other element. According to various embodiments, one or more of the above-described elements may be omitted, or one or more other elements may be added. Alternatively or additionally, a plurality of elements (e.g., modules or programs) may be integrated into a single element. In such a case, according to various embodiments, the integrated element may still perform one or more functions of each of the plurality of elements in the same or similar manner as they are performed by a corresponding one of the plurality of elements before the integration. According to various embodiments, operations performed by the module, the program, or another element may be carried out sequentially, in parallel, repeatedly, or heuristically, or one or more of the operations may be executed in a different order or omitted, or one or more other operations may be added.

What is claimed is:

1. A method for processing user interaction information by an electronic device, the method comprising:
executing an application in an unsecure area of the electronic device;
instantiating an object of the application;
recognizing a user interface of the application, converting a user reaction between a pseudo-event and the instantiated object into data, and transmitting the data to a secure area of the electronic device;
mirroring the application to the secure area by using the data;
based on a user input being detected, inferring an event to be recognized by a graphical user interface (GUI) framework of the electronic device; and
interpreting, in the secure area, the user reaction to the instantiated object corresponding to the inferred event.

2. The method of claim 1, further comprising:
generating input data based on the interpreted user reaction; and
encrypting the input data in the secure area.

3. The method of claim 2, wherein the encrypting the input data comprises encrypting the input data by using a homomorphic encryption system.

4. The method of claim 1, wherein the transmitting the data to the secure area comprises recognizing the user interface and extracting the data from a physical interface corresponding to a valid event.

5. The method of claim 4, wherein the transmitting the data to the secure area further comprises generating key-data pair data of the physical interface corresponding to the user reaction corresponding to the instantiated object.

6. The method of claim 1, wherein the mirroring the application comprises at least one of:
generating the pseudo-event while traversing a reaction list of the instantiated object;
generating virtual user reactions to graphical reactive objects to generate a simulated response to the graphical reactive objects; and
mirroring a rendered image generated to correspond to the pseudo-event to a secure buffer of the secure area.

7. The method of claim 1, wherein the inferring the event to be recognized by the GUI framework comprises inferring the event to be recognized by the GUI framework by using a key-data pair in the secure area.

8. The method of claim 1, wherein the application is developed by using a software development kit (SDK) comprising an oblivious event receipt (OER) function.

9. An electronic device comprising:
a display;
a memory configured to store an application and an operating system; and
a processor configured to execute the application and the operating system stored in the memory and operate while distinguishing between a secure area and a normal area,
wherein the processor is further configured to:
control to execute the application;
instantiate an object of the application;
recognize a user interface of the application, convert a user reaction between a pseudo-event and the instantiated object into data, and transmit the data to the secure area;
mirror the application to the secure area by using the data;
based on a user input being detected, infer an event to be recognized by a graphical user interface (GUI) framework; and
interpret, in the secure area, the user reaction to the instantiated object corresponding to the inferred event.

10. The electronic device of claim 9, wherein the processor is further configured to:
generate input data based on the interpreted user reaction; and
encrypt the input data in the secure area.

11. The electronic device of claim 10, wherein the processor is further configured to encrypt the input data by using a homomorphic encryption system.

12. The electronic device of claim 9, wherein the processor is further configured to recognize the user interface and extract the data from a physical interface corresponding to a valid event.

13. The electronic device of claim 12, wherein the processor is further configured to generate key-data pair data of the physical interface corresponding to the user reaction corresponding to the instantiated object.

14. The electronic device of claim 9, wherein the processor is further configured to:
generate the pseudo-event while traversing a reaction list of the instantiated object;
generate virtual user reactions to graphical reactive objects to generate a simulated response to the graphical reactive objects; and
mirror a rendered image generated to correspond to the pseudo-event to a secure buffer of the secure area.

15. The electronic device of claim 9, wherein the application is developed by using a software development kit (SDK) comprising an oblivious event receipt (OER) function, and
wherein the processor is further configured to infer the event to be recognized by the GUI framework by using a key-data pair in the secure area.

16. A non-transitory computer-readable storage medium storing computer-executable instructions for processing user interaction information that, when executed by at least one processor of an electronic device, cause the electronic device to:
execute an application in an unsecure area of the electronic device;
instantiate an object of the application;
recognize a user interface of the application, convert a user reaction between a pseudo-event and the instantiated object into data, and transmit the data to a secure area of the electronic device;
mirror the application to the secure area by using the data;
based on a user input being detected, infer an event to be recognized by a graphical user interface (GUI) framework of the electronic device; and
interpret, in the secure area, the user reaction to the instantiated object corresponding to the inferred event.

17. The non-transitory computer-readable storage medium of claim 16, wherein the computer-executable instructions, when executed by the at least one processor, further cause the electronic device to:
generate input data based on the interpreted user reaction; and
encrypt the input data in the secure area.

18. The non-transitory computer-readable storage medium of claim 17, wherein to encrypt the input data comprises to encrypt the input data by using a homomorphic encryption system.

19. The non-transitory computer-readable storage medium of claim 16, wherein to transmit the data to the secure area comprises to recognize the user interface and extract the data from a physical interface corresponding to a valid event.

20. The non-transitory computer-readable storage medium of claim 19, wherein to transmit the data to the secure area further comprises to generate key-data pair data of the physical interface corresponding to the user reaction corresponding to the instantiated object.
